(19) United States
(12) Patent Application Publication
(10) Pub. No.: US 2025/0110775 A1
(43) Pub. Date: Apr. 3, 2025

(54) CONFIGURING MICROSERVICES IN CONTAINERIZED SYSTEMS

(71) Applicant: Dell Products L.P., Round Rock, TX (US)

(72) Inventors: Shruty Janakiraman, Cedar Falls, IA (US); David C. Sydow, Merrimack, NH (US)

(21) Appl. No.: 18/479,289

(22) Filed: Oct. 2, 2023

(51) Int. Cl. G06F 9/48; G06F 9/50

(52) U.S. Cl. CPC G06F 9/4856; G06F 9/5016

(57) ABSTRACT

Methods, apparatus, and processor-readable storage media for configuring microservices in containerized systems are provided herein. An example method includes collecting utilization information, over a first time period, for microservices that are implemented using a first container configuration, and generating, for each of the plurality of microservices, at least one corresponding forecast by processing the utilization information using a machine learning model, where the at least one forecast corresponding to a given one of the microservices predicts a utilization of the computing resources by the given microservice over a second time period. The method includes combining the generated forecasts to generate at least one combined forecast for the second time period, determining a second container configuration for the plurality of microservices by evaluating the at least one combined forecast against at least one resource threshold value, and initiating a deployment of the second container configuration of the plurality of microservices.

### BACKGROUND

Information processing systems increasingly utilize reconfigurable virtual resources to meet changing user needs in an efficient, flexible, and cost-effective manner. For example, cloud-based computing and storage systems implemented using virtual resources in the form of containers have been widely adopted.

### SUMMARY

Illustrative embodiments of the disclosure provide techniques for configuring microservices in containerized systems. An exemplary computer-implemented method includes collecting utilization information for a plurality of microservices that are implemented using a first container configuration in a computing environment, wherein the utilization information corresponds to computing resources utilized by the plurality of microservices over a first time period; generating, for each of the plurality of microservices, at least one corresponding forecast by processing at least a portion of the resource utilization information using a machine learning model, wherein the at least one forecast corresponding to a given one of the microservices predicts utilization of the computing resources over a second time period; combining the forecasts generated for the plurality of microservices to generate at least one combined forecast for the second time period; determining a second container configuration for the plurality of microservices by evaluating the at least one combined forecast against at least one resource threshold value; and initiating a deployment of the second container configuration of the plurality of microservices in the computing environment.

Illustrative embodiments can provide significant advantages relative to conventional microservice configuration techniques. For example, technical problems associated with overutilization of resources (e.g., within embedded containerized environments) are mitigated in one or more embodiments by generating usage resource forecasts using a machine learning process and determining a configuration of microservices by processing such forecasts.

These and other illustrative embodiments described herein include, without limitation, methods, apparatus, systems, and computer program products comprising processor-readable storage media.

### BRIEF DESCRIPTION OF THE DRAWINGS

FIG. 1 depicts an example of a container orchestration environment in an illustrative embodiment.

FIG. 2 depicts an information processing system within which the container orchestration environment of FIG. 1 can be implemented in an illustrative embodiment.

FIG. 3 illustrates a system architecture for configuring microservices according to an illustrative embodiment.

FIG. 4 shows an example of a database schema for storing usage data in an illustrative embodiment.

FIG. 5 illustrates a microservice forecasting process in an illustrative embodiment.

FIG. 6 shows a flow diagram of a process for configuring microservices in containerized systems in an illustrative embodiment.

FIGS. 7 and 8 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

As the term is illustratively used herein, a container may be considered lightweight, stand-alone, executable software code that includes elements needed to run the software code. A container-based structure has many advantages including, but not limited to, isolating the software code from its surroundings, and helping reduce conflicts between different tenants or users running different software code on the same underlying infrastructure. The term “user” herein is intended to be broadly construed so as to encompass numerous arrangements of human, hardware, software or firmware entities, as well as combinations of such entities.

In illustrative embodiments, containers may be implemented using a container-based orchestration system, such as a Kubernetes container orchestration system. Kubernetes is an open-source system for automating application deployment, scaling, and management within a container-based information processing system comprised of components referred to as pods, nodes, and clusters. In at least some embodiments, horizontal scaling techniques increase a number of pods as a load (e.g., a number of requests) increases, while vertical scaling techniques assign more resources to existing pods as the load increases.

Types of containers that may be implemented or otherwise adapted within a Kubernetes system include, but are not limited to, Docker containers or other types of Linux containers (LXCs) or Windows containers. Kubernetes has become a prevalent container orchestration system for managing containerized workloads. It is rapidly being adopted by many enterprise-based information technology (IT) organizations to deploy their application programs (applications). By way of example only, such applications may include stateless (or inherently redundant applications) and/or stateful applications. Non-limiting examples of stateful applications may include legacy databases such as Oracle, MySQL, and PostgreSQL, as well as other stateful applications that are not inherently redundant. While the Kubernetes container orchestration system is used to illustrate various embodiments, it is to be understood that alternative container orchestration systems can be utilized.

Generally, for a Kubernetes environment, one or more containers are part of a pod. Thus, the environment may be referred to, more generally, as a pod-based system, a pod-based container system, a pod-based container orchestration system, a pod-based container management system, or the like. Furthermore, a pod is typically considered the smallest execution unit in the Kubernetes container orchestration environment. A pod encapsulates one or more containers, and one or more pods can be executed on a worker node. Multiple worker nodes form a cluster. A Kubernetes cluster is managed by at least one manager node. A Kubernetes environment may include multiple clusters respectively managed by multiple manager nodes. Furthermore, pods typically represent the respective processes running on a cluster. A pod may be configured as a single process wherein one or more containers execute one or more functions that operate together to implement the process. Pods may each have a unique Internet Protocol (IP) address enabling pods to communicate with one another, and for other system components to communicate with each pod. Also, pods may each have persistent storage volumes associated therewith. Configuration information (e.g., configuration objects) indicating how a container executes can be specified for each pod.

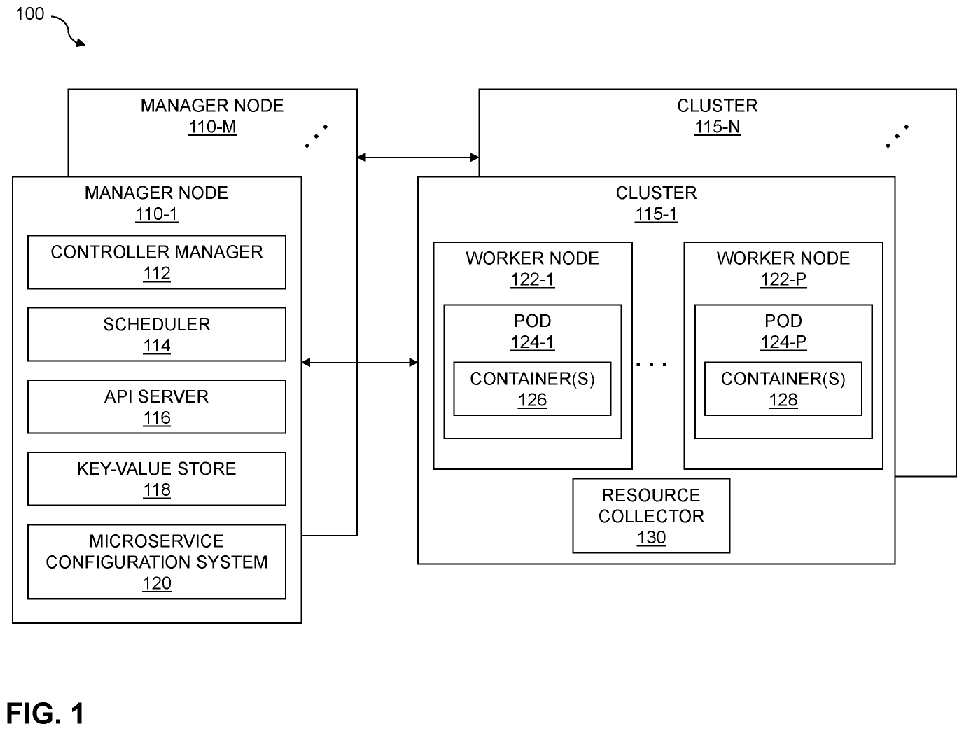

FIG. 1 depicts an example of a container orchestration environment 100 in an illustrative embodiment. In the example shown in FIG. 1, a plurality of manager nodes 110-1, . . . 110-M (herein each individually referred to as a manager node 110 or collectively as manager nodes 110) are operatively coupled to a plurality of clusters 115-1, . . . 115-N (herein each individually referred to as a cluster 115 or collectively as clusters 115). As mentioned above, each cluster 115 is managed by at least one manager node 110.

Each cluster 115 comprises a plurality of worker nodes 122-1, . . . 122-P (herein each individually referred to as a worker node 122 or collectively as worker nodes 122). Each worker node 122 comprises a respective pod, i.e., one of a plurality of pods 124-1, . . . 124-P (herein each individually referred to as a pod 124 or collectively as pods 124). However, it is to be understood that one or more worker nodes 122 can run multiple pods 124 at a time. Each pod 124 comprises a set of containers (e.g., containers 126 and 128). It is noted that each pod 124 may also have a different number of containers. As used herein, a pod may be referred to more generally as a containerized workload. As also shown in FIG. 1, each manager node 110 comprises a controller manager 112, a scheduler 114, an application programming interface (API) server 116, a key-value store 118, and a microservice configuration system 120. It is to be appreciated that in some embodiments, multiple manager nodes 110 may share one or more of the same controller manager 112, the same scheduler 114, the same API server 116, the same key-value store 118, and/or the same microservice configuration system 120.

In some embodiments, each cluster 115 comprises at least one respective resource collector 130. Each resource collector 130 is configured to collect information (e.g., pertaining to resource utilization) related to at least some of its corresponding worker nodes 122. The collected information can be obtained and processed by the microservice configuration system 120, as explained in more detail elsewhere herein.

Worker nodes 122 of each cluster 115 execute one or more applications associated with pods 124 (containerized workloads). In some embodiments, each manager node 110 can manage the worker nodes 122, and therefore pods 124 and containers, in its corresponding cluster 115 based at least in part on the information collected by its resource collectors 130. For example, manager node 110-1 can control operations in its corresponding cluster 115-1 utilizing the above-mentioned components (e.g., controller manager 112, scheduler 114, API server 116, key-value store 118, and microservice configuration system 120) based at least in part on the information collected by its resource collector 130.

In general, controller manager 112 executes control processes (e.g., controllers) that are used to manage operations, for example, in the worker nodes 122. Scheduler 114 typically schedules pods to run on particular worker nodes 122 taking into account node resources and application execution requirements such as, but not limited to, deadlines. In general, in a Kubernetes implementation, API server 116 exposes the Kubernetes API, which is the front end of the Kubernetes container orchestration system. Key-value store 118 typically provides key-value storage for all cluster data including, but not limited to, configuration data objects generated, modified, deleted, and otherwise managed, during the course of system operations.

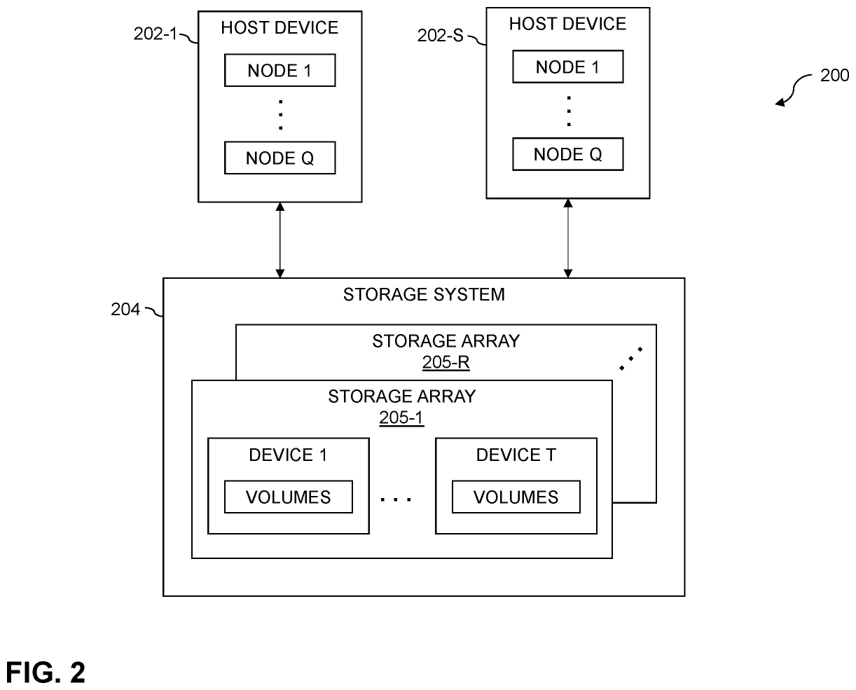

Turning now to FIG. 2, an information processing system 200 is depicted within which the container orchestration environment 100 of FIG. 1 can be implemented. More particularly, as shown in FIG. 2, a plurality of host devices 202-1, . . . 202-S (herein each individually referred to as a host device 202 or collectively as host devices 202) are operatively coupled to a storage system 204. Each host device 202 hosts a set of nodes 1, . . . Q. Note that while multiple nodes are illustrated on each host device 202, a host device 202 can host a single node, and one or more host devices 202 can host a different number of nodes as compared with one or more other host devices 202.

As further shown in FIG. 2, storage system 204 comprises a plurality of storage arrays 205-1, . . . 205-R (herein each individually referred to as a storage array 205 or collectively as storage arrays 205), each of which is comprised of a set of storage devices 1, . . . T upon which one or more storage volumes are persisted. The storage volumes depicted in the storage devices of each storage array 205 can include any data generated in the information processing system 200 but, more typically, include data generated, manipulated, or otherwise accessed, during the execution of one or more applications in the nodes of host devices 202. One or more storage arrays 205 may comprise a different number of storage devices as compared with one or more other storage arrays 205.

Furthermore, any one of nodes 1, . . . Q on a given host device 202 can be a manager node 110 or a worker node 122 (FIG. 1). In some embodiments, a node can be configured as a manager node for one execution environment and as a worker node for another execution environment.

Thus, the components of container orchestration environment 100 in FIG. 1 can be implemented on one or more of host devices 202, such that data associated with pods 124 (FIG. 1) running on the nodes 1, . . . Q is stored as persistent storage volumes in one or more of the storage devices 1, . . . T of one or more of storage arrays 205.

Host devices 202 and storage system 204 of information processing system 200 are assumed to be implemented using at least one processing platform comprising one or more processing devices each having a processor coupled to a memory. Such processing devices can illustratively include particular arrangements of compute, storage, and network resources. In some alternative embodiments, one or more host devices 202 and storage system 204 can be implemented on respective distinct processing platforms.

The term “processing platform” as used herein is intended to be broadly construed so as to encompass, by way of illustration and without limitation, multiple sets of processing devices and associated storage systems that are configured to communicate over one or more networks. For example, distributed implementations of information processing system 200 are possible, in which certain components of the system reside in one data center in a first geographic location while other components of the system reside in one or more other data centers in one or more other geographic locations that are potentially remote from the first geographic location. Thus, it is possible in some implementations of information processing system 200 for portions or components thereof to reside in different data centers. Numerous other distributed implementations of information processing system 200 are possible. Accordingly, the constituent parts of information processing system 200 can also be implemented in a distributed manner across multiple computing platforms.

Additional examples of processing platforms utilized to implement containers, container environments, and container management systems in illustrative embodiments, such as those depicted in FIGS. 1 and 2, will be described in more detail below in conjunction with additional figures.

It is to be appreciated that these and other features of illustrative embodiments are presented by way of example only, and should not be construed as limiting in any way.

Accordingly, different numbers, types and arrangements of system components can be used in other embodiments. Although FIG. 2 shows an arrangement wherein host devices 202 are coupled to just one plurality of storage arrays 205, in other embodiments, host devices 202 may be coupled to and configured for operation with storage arrays across multiple storage systems similar to storage system 204. The functionality associated with the elements 112, 114, 116, 118, and/or 120 in other embodiments can also be combined into a single module, or separated across a larger number of modules. As another example, multiple distinct processors can be used to implement different ones of the elements 112, 114, 116, 118, and/or 120 or portions thereof.

At least portions of elements 112, 114, 116, 118, and/or 120 may be implemented at least in part in the form of software that is stored in memory and executed by a processor.

It should be understood that the particular sets of components implemented in information processing system 200 as illustrated in FIG. 2 are presented by way of example only. In other embodiments, only subsets of these components, or additional or alternative sets of components, may be used, and such components may exhibit alternative functionality and configurations. Additional examples of systems implementing container management functionality will be described below.

Still further, information processing system 200 may be part of a public cloud infrastructure. The cloud infrastructure may also include one or more private clouds and/or one or more hybrid clouds (e.g., a hybrid cloud is a combination of one or more private clouds and one or more public clouds).

A Kubernetes pod may be referred to more generally herein as a containerized workload. One example of a containerized workload is an application program configured to provide a microservice. A microservice architecture is a software approach wherein a single application is composed of a plurality of loosely-coupled and independently-deployable smaller components or services.

Container-based microservice architectures have changed the way development and operations teams test and deploy modern software. Containers help companies modernize by making it easier to scale and deploy applications. The pod brings the containers together and makes it easier to scale and deploy applications. Kubernetes clusters allow containers to run across multiple machines and environments: such as virtual, physical, cloud-based, and on-premises environments. As shown and described above in the context of FIG. 1, Kubernetes clusters are generally comprised of one manager (master) node and one or more worker nodes. These nodes can be physical computers or virtual machines (VMs), depending on the cluster. Typically, a given cluster is allocated a fixed number of resources (e.g., central processing unit (CPU), memory, and/or other computer resources), and when a container is defined the number of resources from among the resources allocated to the cluster is specified. When the container starts executing, pods are created on the deployed container that will serve the incoming requests.

In more detail, Kubernetes enables a multi-cluster environment by sharing and abstracting the underlying compute, network, and storage physical infrastructure, e.g., as illustrated and described above in the context of FIG. 2. With shared compute/storage/network resources, the nodes are enabled and added to the Kubernetes cluster. The pod network allows identification of the pod across the network with PodIPs. With this cluster, a pod can run in any node and scale based on a replica set.

The number of pods needed to run for the cluster can be defined using the replica set. When the container loads, the defined number of pods will be loaded for that service. A larger number of pods means a larger resource allocation. The amount of memory and CPU that the container can use for a cluster and a pod can also be defined. If the load of a microservice in a given cluster increases, then the container generally will continue to spin (e.g., add) additional pods to support the increased load. In some instances, this can cause the container to fail, which results in all of the microservices in that container becoming unresponsive. In such instances, the container may need to be restarted and/or additional resources may need to be allocated to the container. The pending requests for the microservices in that container will also be lost.

Container-based systems are increasingly being utilized by modern enterprise systems. It is important to ensure container resources are properly utilized in such systems. For example, overutilization of container resources can lead to serious problems including, for example, out of memory (OOM) errors, unexpected system latency, and/or system failures. This is particularly important for containerized embedded systems. The term “containerized embedded system” in this context and elsewhere herein is intended to be broadly construed so as to encompass, for example, systems having a specific number of one or more resources that are divided among one or more discrete resource spaces (also referred to as containers). As a non-limiting example, a containerized embedded system may include a specific amount of CPU and/or memory resources that are divided into one or more discrete CPU and memory spaces (referred to as containers). In at least some examples, at least some of the resources in a containerized embedded system cannot be added or upgraded virtually. It is to be appreciated that such containers can be controlled by a container management system, such as a Kubernetes system and/or a Docker system.

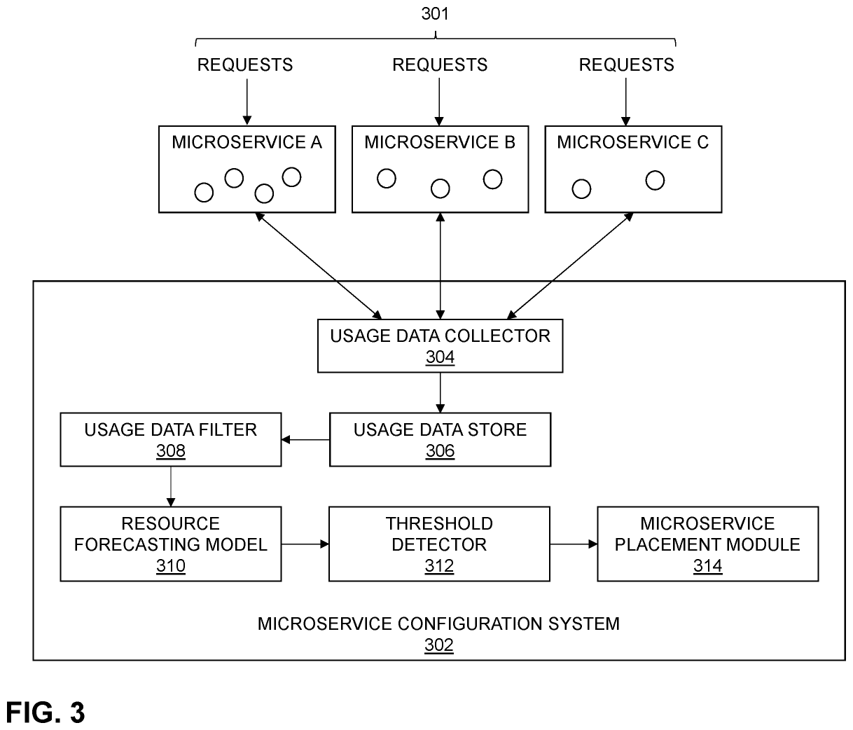

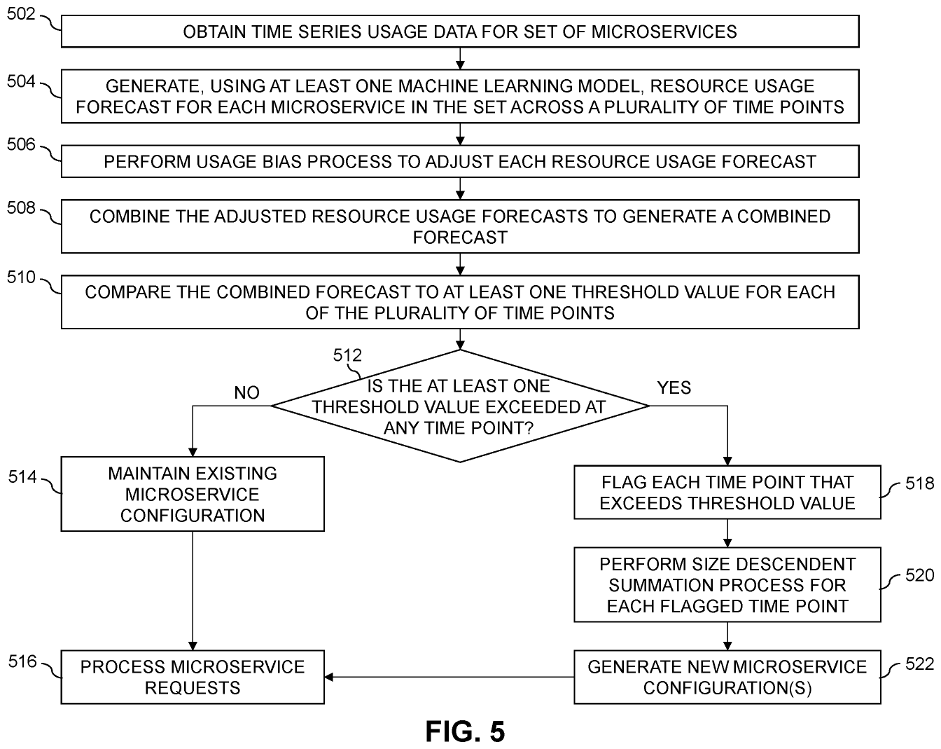

FIG. 3 illustrates a system architecture for configuring microservices according to an illustrative embodiment. More particularly, the system architecture comprises a plurality of elements, illustratively interconnected as shown. The elements can be configured to implement a microservice clustering process, such as the process described in conjunction with FIG. 5.

The example shown in FIG. 3 includes a microservice configuration system 302 (e.g., corresponding to the microservice configuration system 120), and three microservices (labeled as microservice A, microservice B, microservice C), which, in some embodiments, can be implemented using a set of pods (as indicated by the circles in FIG. 3).

The microservice configuration system 302 includes a usage data collector 304, a usage data store 306, a usage data filter 308, a resource forecasting model 310, a threshold detector 312, and a microservice placement module 314.

The usage data collector 304 includes functionality for collecting and storing usage data, associated with the microservices, in the usage data store 306. For example, the usage data can correspond resource consumption information, associated with one or more requests 301, for each of the microservices A-C. The usage data collector 304, in some embodiments, can be implemented as a software service that periodically extracts the usage data from the microservices. As a non-limiting example, for a Linux-based system that implements Docker containers, the usage data collector 304 can collect the usage data by periodically executing a combination of table of process (top) commands and/or Docker commands.

The usage data for each microservice can be collected at a designated frequency (e.g., every seconds). For example, the frequency can be specified by a user and/or selected based on one or more system constraints (e.g., storage or network capacities associated with microservice configuration system 302), a number of microservices, and/or a number of containers. In at least some embodiments, the usage data collector 304 can be configured to collect the usage data over a designated time period (e.g., a period of 2 days). The length of time can be configured so that there are enough training samples to predict usage trends (e.g., seasonal trends) for a particular day. In at least some embodiments, a retention length of the usage data can be configured using a set of parameter values. For example, the set of parameter values may include one or more of: a maximum retention period, a maximum number of entries to retain, and a maximum number of entries of processes to capture.

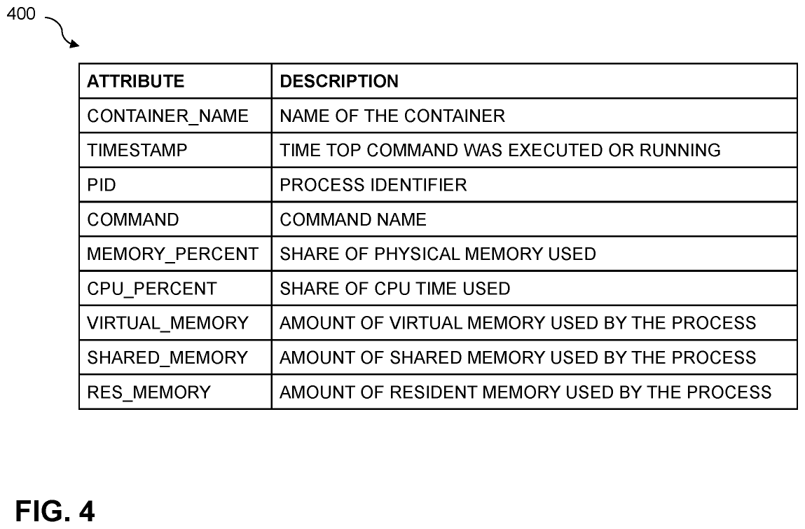

In one or more embodiments, the usage data collector 304 may store the collected usage data in the usage data store 306 in accordance with a particular database schema. FIG. 4 shows a non-limiting example of a database schema 400 for storing usage data in an illustrative embodiment. The database schema 400 includes attributes and corresponding descriptions for metrics collected for microservices. It is to be appreciated that this particular database schema 400 is only an example, and additional or alternative attributes can be used in other embodiments.

According to one embodiment, the usage data filter 308 can identify each microservice in the context of a container based on the process name stored in the usage data store 306. The usage data filter 308 can then apply one or more rules to the usage data to determine which of the microservices A-C are eligible to be moved.

One non-limiting example of a rule includes determining that a given microservice is eligible to move if peak CPU usage for the microservice satisfies a CPU threshold value (e.g., 20% of total CPU utilization) for a designated amount of time (e.g., 5 minutes). It is noted that infrequent short CPU spikes are not ideal but often do not lead to system degradation. Accordingly, in some embodiments, the rule can also consider whether or not the threshold was exceeded over multiple time intervals.

Another non-limiting example of a rule includes determining that a given microservice is eligible to move if peak memory usage for the microservice satisfies a memory threshold value (e.g., 10% of total memory allocated to the container) over a designated amount of time (e.g., 5 minutes). If so, then the usage data filter 308 can determine that the microservice is eligible to be moved. Unlike CPU resources, a single instance of memory overutilization can lead to errors (e.g., negative OOM errors). Thus, in at least some embodiments, the usage data filter 308 does not consider a minimum length of time when determining which microservices are eligible to be moved.

The resource forecasting model 310 generally comprises a machine learning model that is configured to process time series data, such as a recurrent neural network (RNN). It is noted that metrics corresponding to memory usage and CPU usage are often correlated (e.g., high CPU usage indicates work being done in a process, which often causes increased memory consumption, and vice versa). In some embodiments, the resource forecasting model 310 can comprise a multivariate Long Short-Term Memory (LSTM) model that is trained to forecast CPU usage and memory usage.

Generally, a multivariate LSTM model is a type of RNN that is capable of learning long-term (e.g., temporal) dependencies between multiple variables in time series data. LSTM models can process an entire sequence of data using feedback connections. An LSTM model can include a plurality of LSTM units, where each LSTM unit comprises a cell state and three logical gates (an input gate, an output gate, and a forget gate). The forget gate decides which information from the previous cell state should be forgotten (e.g., by applying a sigmoid function). The input gate controls the information flow to the current cell state, and the output gate decides which information should be passed on to the next hidden state. It is to be appreciated that other machine learning models can be used in other embodiments, including other RNN-based models or possibly transformer-based models.

In at least one embodiment, the resource forecasting model 310 can obtain input data from the usage data store 306 corresponding to microservices eligible to move, as determined by the usage data filter 308. For example, the input data may correspond to one or more of the attributes in the database schema 400 (e.g., cpu_percent, res_memory, virtual_memory, and/or shared_memory). The resource forecasting model 310 can output a forecast for CPU utilization and a forecast for memory utilization for each microservice that is eligible to move.

The threshold detector 312 includes functionality for generating information (e.g., a list) indicating which microservices should and/or should not be grouped together based on the forecasts output by the resource forecasting model 310, as explained in more detail in conjunction with FIG. 5.

The microservice placement module 314 can then determine a new configuration that moves one or more of the microservices (e.g., microservices A-C) into new or different containers. In at least one embodiment, the microservice placement module 314 can automatically move and/or create containers to implement the new configuration. Alternatively, or additionally, the information can be output to a user (e.g., a system administrator) for verification before the configuration is implemented.

It is to be appreciated that at least some of the functionality associated with elements 304, 306, 308, 310, 312, and/or 314 of the microservice configuration system 302 in other embodiments can be implemented on other systems and/or devices. As a non-limiting example, the usage data collector 304 may comprise auxiliary applications associated with the respective microservices that transmit usage data to the microservice configuration system 302.

FIG. 5 illustrates a microservice forecasting process in an illustrative embodiment. It is to be understood that this particular process is only an example, and additional or alternative processes can be carried out in other embodiments.

In this embodiment, the process includes steps 502 through 522. These steps can be performed at least in part by microservice configuration system 302.

Step 502 includes obtaining time series usage data for a set of microservices. It is assumed that the set of microservices is implemented in a container-based system (e.g., information processing system 200), and that each of the microservices in the set has been identified as being eligible to move to a new or different container, as described in conjunction with usage data filter 308, for example.

Step 504 includes generating, using at least one machine learning model (e.g., resource forecasting model 310), resource usage forecasts for each microservice in the set across a plurality of time points. The resource usage forecasts can include CPU and/or memory forecasts for each microservice in the set, for example.

Step 506 includes performing a usage bias process to adjust each resource usage forecast. Generally, the usage bias process adjusts the resource usage forecast so that it is biased towards overutilization. In some embodiments, this can be accomplished by increasing the estimated length of CPU and memory usage generated by the LSTM. As a more particular example, consider a resource usage forecast that includes time series data for a given microservice, m, over a set of time points, A. The usage bias process can include determining that the maximum utilization of a resource across a consecutive number of time points in the set A (e.g., across three time points), and then increasing the utilization of the resource to the maximum utilization for each of the consecutive time points. Accordingly, the usage bias process can be expressed as follows:

$$A = 〈 {R}_{t ,} {R}_{t + 1} , ... {R}_{t + N} 〉$$

$${f}^{″} A = 〈 max ( x , x + 1 , x + 2 ) : x ∈ A 〉$$

where Rₜ, represents a predicted value of a resource at time t, and f″A represents an image of set A in which each element is the maximum of Rₜ, Rₜ₊₁, Rₜ₊₂.

Step 508 includes combining the adjusted resource usage forecasts to generate a combined forecast. For example, forecasts generated for the set of microservices, M, can be aligned based on times stamps. Then, the predicted values of each microservice can be combined as follows:

$$X = 〈 {M}_{1 ,} {M}_{2} , ... , {M}_{N} 〉$$

$$A = 〈 {R}_{t ,} {R}_{t + 1} , ... {R}_{t + N} 〉$$

$$Z = \{ {R}_{1 ,} 〈 {M}_{1 , t ,} {M}_{2 , t} {M}_{N , t} 〉 , ... , {R}_{i ,} 〈 {M}_{1 , t + i ,} {M}_{2 , t + 1} , ... {M}_{N , t + i} 〉 \}$$

$$f ( x ) = {\sum }_{i = 1}^{\vert R \vert} {M}_{i , x}$$

$${f}^{″} Z = 〈 f ( x ) : x ∈ Z 〉$$

Accordingly, f″Z represents an array of values, containing a list of time points, with each time point representing the sum of resources used across all microservices. This process can be performed separately for CPU resources and memory resources (e.g., resident memory usage).

Step 510 includes comparing the combined forecast to at least one threshold value (e.g., corresponding to a resource limit, L) for each of the plurality of time points.

Step 512 includes a test to determine if at least one threshold value is exceeded at any time point. For example, step 512 can include evaluating each data point in f″Z against the threshold value.

If the result of step 512 is no, then the process continues to step 514, which includes maintaining the existing microservice configuration. Step 516 includes processing one or more microservice requests, which in this case would be based on the existing microservice configuration.

If the result of step 512 is yes, then the process continues to step 518.

Step 518 includes flagging each time point that exceeds the at least one threshold value. In at least some embodiments, a time point can be flagged according to the following rules: (1) if any three contiguous points in the series f″Z are over a CPU utilization threshold value (e.g., 90% utilization), then flag the median time point; and (2) if a single time point in the series f″Z is over a memory utilization threshold value (e.g., 100% memory utilization), then flag the time point.

Step 520 includes performing a size descendent summation process for each flagged time point, T. Each of the flagged time points T will be added to a list F, as follows:

$$F = \{ {T}_{1 ,} 〈 {M}_{1 , t ,} {M}_{2 , t} {M}_{N , t} 〉 , ... , {T}_{i ,} 〈 {M}_{1 , t + i ,} {M}_{2 , t + 1} , ... {M}_{N , t + i} 〉 \}$$

As a non-limiting example, the size descendent summation process can include the following steps:
1. Sort forecasted CPU utilization values at point T in ascending order for the set of microservices M.
2. Combine the forecasted CPU utilization values for consecutive microservices (Mᵢ and Mᵢ₊₁) until the combined value exceeds a CPU threshold usage value.
3. Combine the forecasted memory utilization values for consecutive microservices (Mᵢ and Mᵢ₊₁) until the combined value exceeds a memory threshold usage value.
4. When at least one of the CPU threshold usage values and the memory threshold usage values is reached, assign microservices from Mᵢ to M_{iCURRENT} to a same group.
5. Repeat steps 2 through 4 until all microservices in the set have been assigned.

Step 522 includes generating one or more new microservice configurations. For example, a new microservice configuration can be generated based on the groups determined at step 520 for each of the flagged time points. Optionally, some embodiments can include removing one or more of the flagged time points from the list F prior to performing step 520. As a non-limiting example, if the time between a first one of the flagged time points and a second one of the flagged time points does not satisfy a threshold time value, then the second flagged time point can be removed from the list F to prevent the microservice configuration from changing too frequently.

The process continues to step 516 which includes processing one or more microservice requests, which in this case would be processed using the new microservice configuration.

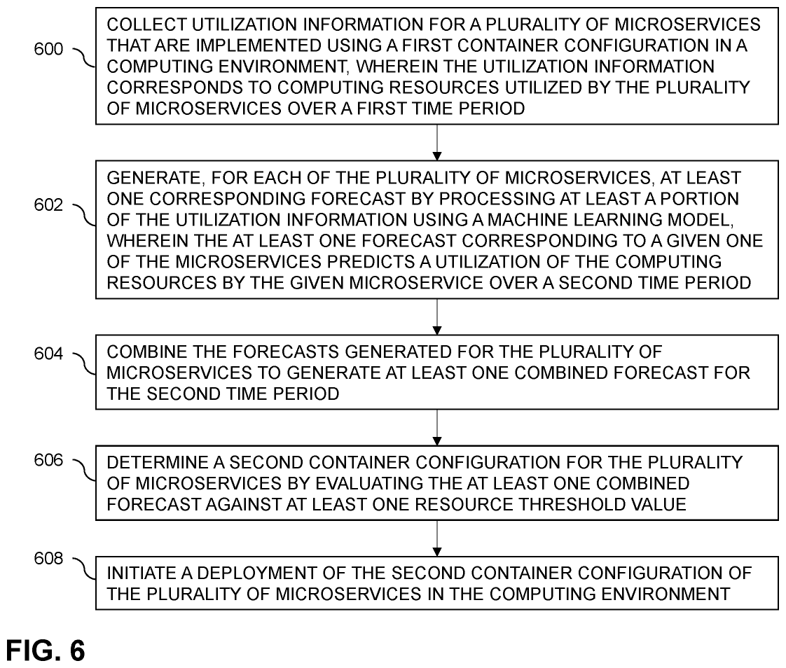

FIG. 6 shows a flow diagram of a process for configuring microservices in an illustrative embodiment. It is to be understood that this particular process is only an example, and additional or alternative processes can be carried out in other embodiments. In this embodiment, the process includes steps 600 through 608. These steps are assumed to be performed at least in part by a microservice configuration system 302 utilizing at least portions of its elements 304, 306, 308, 310, 312, and/or 314.

Step 600 includes collecting utilization information for a plurality of microservices that are implemented using a first container configuration in a computing environment, wherein the utilization information corresponds to computing resources utilized by the plurality of microservices over a first time period. Step 602 includes generating, for each of the plurality of microservices, at least one corresponding forecast by processing at least a portion of the utilization information using a machine learning model, wherein the at least one forecast corresponding to a given one of the microservices predicts a utilization of the computing resources by the given microservice over a second time period. Step 604 includes combining the forecasts generated for the plurality of microservices to generate at least one combined forecast for the second time period. Step 606 includes determining a second container configuration for the plurality of microservices by evaluating the at least one combined forecast against at least one resource threshold value. Step 608 includes initiating a deployment of the second container configuration of the plurality of microservices in the computing environment.

The computing resources utilized by the plurality of microservices may include processing resources and memory resources. For the given microservice, the machine learning model may generate a first forecast corresponding to the processing resources and a second forecast corresponding to the memory resources. The machine learning model may include a multivariate long short-term memory model that is trained to identify dependencies corresponding to the processing resources and the memory resources. The collecting may include filtering the utilization information based on at least one of an amount of time the processing resources of the given microservice exceeded a first filtering threshold value in the first time period, and whether the memory resources of the given microservice exceeded a second filtering threshold value in the first time period.

The utilization information collected for the given microservice may include at least one of one or more container identifiers, one or more process identifiers, processing resource utilization information for the given microservice at a plurality of time points, and memory resource utilization information for the given microservice at a plurality of time points. The collected utilization information may be stored according to a designated database schema. The process can further include a step of adjusting the forecasts generated for the plurality of microservices to add a bias towards overutilization of the computing resources. Initiating the second container configuration may include at least one of moving at least one of the plurality of microservices to a different container selected from among a plurality of existing containers associated with the computing environment, and moving at least one of the plurality of microservices to a new container. Initiating the second container configuration may include providing an indication of the second container configuration to at least one user. The computing environment may include a containerized embedded system. For example, the containerized embedded system may include a fixed amount of processing resources and/or a fixed amount of memory resources.

Accordingly, the particular processing operations and other functionality described in conjunction with the flow diagram of FIG. 6 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to mitigate errors, system failures, and/or latency of a container-based system by collecting and filtering utilization information, generating forecasts using a machine learning process based on the filtered information, and determining a microservices configuration based on such forecasts. These and other embodiments can effectively overcome problems associated with overutilization of resources, particularly in embedded containerized environments.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the container orchestration environment 100 and/or information processing system 200 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of LXC. The containers are run on virtual machines in a multi-tenant environment, although other arrangements are possible. The containers are utilized to implement a variety of different types of functionalities within the container orchestration environment 100 and/or information processing system 200. For example, containers can be used to implement respective processing devices providing compute and/or storage services of a cloud-based system. Again, containers may be used in combination with other virtualization infrastructure such as virtual machines implemented using a hypervisor.

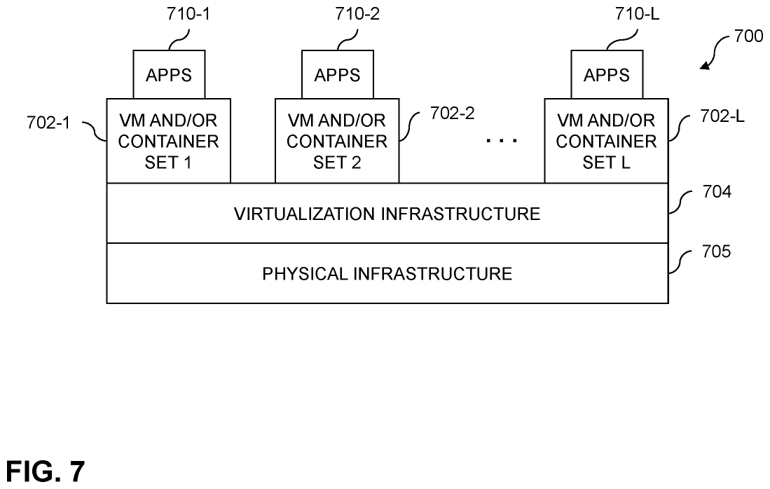

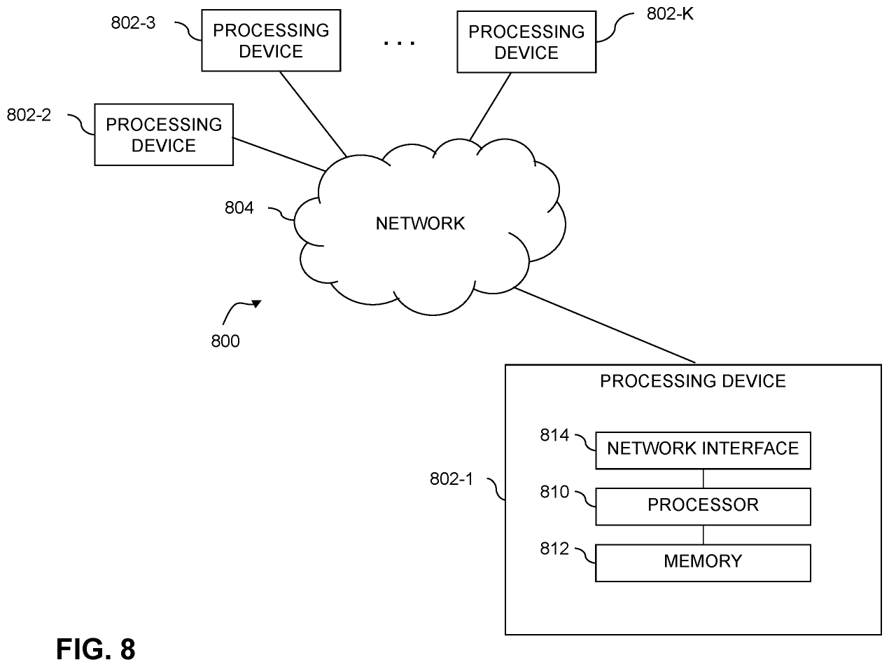

Illustrative embodiments of processing platforms will now be described in greater detail with reference to FIGS. 7 and 8. Although described in the context of container orchestration environment 100 and/or information processing system 200, these platforms may also be used to implement at least portions of other information processing systems in other embodiments.

FIG. 7 shows an example processing platform comprising cloud infrastructure 700. The cloud infrastructure 700 comprises a combination of physical and virtual processing resources that are utilized to implement at least a portion of the container orchestration environment 100 and/or information processing system 200. The cloud infrastructure 700 comprises multiple VMs and/or container sets 702-1, 702-2, . . . 702-L implemented using virtualization infrastructure 704. The virtualization infrastructure 704 runs on physical infrastructure 705, and illustratively comprises one or more hypervisors and/or operating system level virtualization infrastructure. The operating system level virtualization infrastructure illustratively comprises kernel control groups of a Linux operating system or other type of operating system.

The cloud infrastructure 700 further comprises sets of applications 710-1, 710-2, . . . 710-L running on respective ones of the VMs/container sets 702-1, 702-2, . . . 702-L under the control of the virtualization infrastructure 704. The VMs/container sets 702 comprise respective VMs, respective sets of one or more containers, or respective sets of one or more containers running in VMs. In some implementations of the FIG. 7 embodiment, the VMs/container sets 702 comprise respective VMs implemented using virtualization infrastructure 704 that comprises at least one hypervisor.

A hypervisor platform may be used to implement a hypervisor within the virtualization infrastructure 704, wherein the hypervisor platform has an associated virtual infrastructure management system. The underlying physical machines comprise one or more distributed processing platforms that include one or more storage systems.

In other implementations of the FIG. 7 embodiment, the VMs/container sets 702 comprise respective containers implemented using virtualization infrastructure 704 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of container orchestration environment 100 and/or information processing system 200 may each run on a computer, server, storage device or other processing platform element. A given such element is viewed as an example of what is more generally referred to herein as a “processing device.” The cloud infrastructure 700 shown in FIG. 7 may represent at least a portion of one processing platform. Another example of such a processing platform is processing platform 800 shown in FIG. 8.

The processing platform 800 in this embodiment comprises a portion of container orchestration environment 100 and/or information processing system 200 and includes a plurality of processing devices, denoted 802-1, 802-2, 802-3, . . . 802-K, which communicate with one another over a network 804.

The processing device 802-1 in the processing platform 800 comprises a processor 810 coupled to a memory 812.

The processor 810 processor coupled to a memory and a network interface.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory 812 comprises random access memory (RAM), read-only memory (ROM) or other types of memory, in any combination. The memory 812 and other memories disclosed herein should be viewed as illustrative examples of what are more generally referred to as “processor-readable storage media” storing executable program code of one or more software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

Also included in the processing device 802-1 is network interface circuitry 814, which is used to interface the processing device with the network 804 and other system components, and may comprise conventional transceivers.

The other processing devices 802 of the processing platform 800 are assumed to be configured in a manner similar to that shown for processing device 802-1 in the figure.

Again, the particular processing platform 800 shown in the figure is presented by way of example only, and container orchestration environment 100 and/or information processing system 200 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the container orchestration environment 100 and/or information processing system 200. Such components can communicate with other elements of the container orchestration environment 100 and/or information processing system 200 over any type of network or other communication media.

For example, particular types of storage products that can be used in implementing a given storage system of a distributed processing system in an illustrative embodiment include network-attached storage (NAS), storage area networks (SANs), direct-attached storage (DAS) and distributed DAS, as well as combinations of these and other storage types, including software-defined storage.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
collecting utilization information for a plurality of microservices that are implemented using a first container configuration in a computing environment, wherein the utilization information corresponds to computing resources utilized by the plurality of microservices over a first time period;
generating, for each of the plurality of microservices, at least one corresponding forecast by processing at least a portion of the utilization information using a machine learning model, wherein the at least one forecast corresponding to a given one of the microservices predicts a utilization of the computing resources by the given microservice over a second time period;
combining the forecasts generated for the plurality of microservices to generate at least one combined forecast for the second time period;
determining a second container configuration for the plurality of microservices by evaluating the at least one combined forecast against at least one resource threshold value; and
initiating a deployment of the second container configuration of the plurality of microservices in the computing environment;
wherein the method is performed by at least one processing device comprising a processor coupled to a memory.

2. The computer-implemented method of claim 1, wherein the computing resources utilized by the plurality of microservices comprise processing resources and memory resources.

3. The computer-implemented method of claim 2, wherein, for the given microservice, the machine learning model generates a first forecast corresponding to the processing resources and a second forecast corresponding to the memory resources.

4. The computer-implemented method of claim 2, wherein the machine learning model comprises a multivariate long short-term memory model that is trained to identify dependencies corresponding to the processing resources and the memory resources.

5. The computer-implemented method of claim 2, wherein the collecting comprises filtering the utilization information based on at least one of:
an amount of time the processing resources of the given microservice exceeded a first filtering threshold value in the first time period; and
whether the memory resources of the given microservice exceeded a second filtering threshold value in the first time period.

6. The computer-implemented method of claim 1, wherein the utilization information collected for the given microservice comprises at least one of:
one or more container identifiers;
one or more process identifiers;
processing resource utilization information for the given microservice at a plurality of time points; and
memory resource utilization information for the given microservice at a plurality of time points.

7. The computer-implemented method of claim 1, wherein the collected utilization information is stored according to a designated database schema.

8. The computer-implemented method of claim 1, further comprising:
adjusting the forecasts generated for the plurality of microservices to add a bias towards overutilization of the computing resources.

9. The computer-implemented method of claim 1, wherein initiating the second container configuration comprises at least one of:
moving at least one of the plurality of microservices to a different container selected from among a plurality of existing containers associated with the computing environment; and
moving at least one of the plurality of microservices to a new container.

10. The computer-implemented method of claim 1, wherein initiating the second container configuration comprises:
providing an indication of the second container configuration to at least one user.

11. The computer-implemented method of claim 1, wherein the computing environment comprises a containerized embedded system.

12. A non-transitory processor-readable storage medium having stored therein program code of one or more software programs, wherein the program code when executed by at least one processing device causes the at least one processing device:
to collect utilization information for a plurality of microservices that are implemented using a first container configuration in a computing environment, wherein the utilization information corresponds to computing resources utilized by the plurality of microservices over a first time period;
to generate, for each of the plurality of microservices, at least one corresponding forecast by processing at least a portion of the utilization information using a machine learning model, wherein the at least one forecast corresponding to a given one of the microservices predicts a utilization of the computing resources by the given microservice over a second time period;
to combine the forecasts generated for the plurality of microservices to generate at least one combined forecast for the second time period;
to determine a second container configuration for the plurality of microservices by evaluating the at least one combined forecast against at least one resource threshold value; and
to initiate a deployment of the second container configuration of the plurality of microservices in the computing environment.

13. The non-transitory processor-readable storage medium of claim 12, wherein the computing resources utilized by the plurality of microservices comprise processing resources and memory resources.

14. The non-transitory processor-readable storage medium of claim 13, wherein, for the given microservice, the machine learning model generates a first forecast corresponding to the processing resources and a second forecast corresponding to the memory resources.

15. The non-transitory processor-readable storage medium of claim 13, wherein the machine learning model comprises a multivariate long short-term memory model that is trained to identify dependencies corresponding to the processing resources and the memory resources.

16. The non-transitory processor-readable storage medium of claim 13, wherein the collecting comprises filtering the utilization information based on at least one of:
an amount of time the processing resources of the given microservice exceeded a first filtering threshold value in the first time period; and
whether the memory resources of the given microservice exceeded a second filtering threshold value in the first time period.

17. An apparatus comprising:
at least one processing device comprising a processor coupled to a memory;
the at least one processing device being configured:
to collect utilization information for a plurality of microservices that are implemented using a first container configuration in a computing environment, wherein the utilization information corresponds to computing resources utilized by the plurality of microservices over a first time period;
to generate, for each of the plurality of microservices, at least one corresponding forecast by processing at least a portion of the utilization information using a machine learning model, wherein the at least one forecast corresponding to a given one of the microservices predicts a utilization of the computing resources by the given microservice over a second time period;
to combine the forecasts generated for the plurality of microservices to generate at least one combined forecast for the second time period;
to determine a second container configuration for the plurality of microservices by evaluating the at least one combined forecast against at least one resource threshold value; and
to initiate a deployment of the second container configuration of the plurality of microservices in the computing environment.

18. The apparatus of claim 17, wherein the computing resources utilized by the plurality of microservices comprise processing resources and memory resources.

19. The apparatus of claim 18, wherein, for the given microservice, the machine learning model generates a first forecast corresponding to the processing resources and a second forecast corresponding to the memory resources.

20. The apparatus of claim 18, wherein the machine learning model comprises a multivariate long short-term memory model that is trained to identify dependencies corresponding to the processing resources and the memory resources.
